(19) United States
(12) Patent Application Publication
(10) Pub. No.: US 2006/0092399 A1
(43) Pub. Date: May 4, 2006

(54) Lithographic apparatus, a control system for controlling a lithographic apparatus, and a device manufacturing method

(75) Inventor: David Christopher Ockwell, Waalre (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 10/976,157

(22) Filed: Oct. 29, 2004

(51) Int. Cl. G03B 27/58

(52) U.S. Cl. 355/72; 355/53

(57) ABSTRACT

The present invention relates to a lithographic apparatus that includes a substrate table constructed and arranged to hold a plurality of substrates at a plurality of respective exposable locations on the substrate table, and a projection system constructed and arranged to project a patterned radiation beam onto a target portion of the plurality of substrates at the exposable locations.

### FIELD

The present invention relates to lithographic apparatus, a control system for controlling a lithographic apparatus, a method of controlling a lithographic apparatus, a substrate handler, a method of handling a plurality of substrates, a substrate handling apparatus, and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction), while synchronously scanning the substrate parallel or anti-parallel to this direction. It is also possible to transfer the pattern from the patterning device to the substrate by imprinting the pattern onto the substrate.

### SUMMARY

According to an embodiment of the invention, there is provided a lithographic apparatus that includes a substrate table that is constructed and arranged to hold a plurality of substrates at a plurality of respective exposable locations on the substrate table, and a projection system constructed and arranged to project a patterned radiation beam onto respective target portions of the plurality of substrates at the exposable locations.

According to an embodiment of the invention, there is provided a lithographic projection apparatus arranged to project a pattern from a patterning device onto a plurality of substrates. The plurality of substrates are mounted on a single substrate table constructed to hold the plurality of substrates at a plurality of exposable locations, respectively.

According to an embodiment of the invention, there is provided a lithographic apparatus arranged to transfer a pattern from a patterning device onto a plurality of substrates. The plurality of substrates are disposed on a substrate table constructed to hold the plurality of substrates at a plurality of exposable locations, respectively.

According to an embodiment of the invention, there is provided a control system for controlling a lithographic apparatus. The control system includes a data creation unit for creating data relating to a plurality of substrates held at a plurality of exposable locations on a substrate table, respectively, a data maintaining unit for maintaining the data relating to the plurality of substrates held on the substrate table, a substrate height measuring unit for measuring the height of the plurality of substrates held on the substrate table, and a data storage unit for storing alignment grids, or exposure data, or identification data, or any combination thereof, associated with each of the plurality of substrates held on the substrate table.

According to an embodiment of the invention, there is provided a method of controlling a lithographic apparatus. The method includes creating data relating to a plurality of substrates held at a plurality of exposable locations on a substrate table, respectively, maintaining the data relating to the plurality of substrates held on the substrate table, measuring the height of the plurality of substrates held on the substrate table, storing alignment grids, or exposure data, or identification data, or any combination thereof, associated with each of the plurality of substrates held on the substrate table, and controlling the lithographic apparatus based on the stored data.

According to an embodiment of the invention, there is provided a substrate handler for handling a plurality of substrates in a lithographic apparatus. The substrate handler includes a first gripper for gripping a first substrate, a second gripper for gripping a second substrate, and a control unit for controlling the first and second grippers so that the first substrate is disposed at a first location on a substrate table and the second substrate is disposed at a second location on the substrate table. The first and second substrates are exposable at the first and second locations on the substrate table, respectively.

According to an embodiment of the present invention, there is provided a method of handling a plurality of substrates in a lithographic apparatus. The method includes gripping a first substrate with a first gripper, gripping a second substrate with a second gripper, and controlling the first and second grippers so that the first substrate is released at a first exposable location on a substrate table and the second substrate is released at a second exposable location on the substrate table.

According to an embodiment of the present invention, there is provided a substrate handling apparatus for processing a plurality of substrates for use in a lithographic apparatus. The handling apparatus includes a first processing track for coating the plurality of substrates to be supplied to the lithographic apparatus, and a second different processing track for developing the plurality of substrates once they exit the lithographic apparatus. The first and second processing tracks are arranged to be operationally compatible with the lithographic apparatus.

According to an embodiment of the present invention, there is provided a substrate handling apparatus for processing a first substrate and a second substrate for use in a lithographic apparatus. The lithographic apparatus includes a substrate table constructed to hold a plurality of substrates at a plurality of exposable locations on the substrate table, respectively, and a projection system configured to project a patterned radiation beam onto a target portion of the plurality of substrates at the exposable locations. The handling apparatus includes a first processing track and a second processing track. The first processing track is arranged to coat the first substrate to be supplied to the lithographic apparatus, and to develop the first substrate once it exits the lithographic apparatus, and the second processing track is arranged to coat the second substrate to be supplied to the lithographic apparatus, and to develop the second substrate once it exits the lithographic apparatus. The first and second processing tracks are arranged to be operationally compatible with the lithographic apparatus.

According to an embodiment of the present invention, there is provided a substrate handler for use in a lithographic apparatus. The lithographic apparatus includes a substrate table constructed to hold a plurality of substrates at a plurality of exposable locations on the substrate table, respectively, and a projection system configured to project a patterned radiation beam onto a target portion of the plurality of substrates at the exposable locations. The substrate handler includes a carrier for carrying a plurality of substrates, and a loader for loading the plurality of substrates simultaneously to a plurality of respective exposure locations on the substrate table.

According to an embodiment of the present invention, there is provided a substrate handler for use in a lithographic apparatus. The lithographic apparatus includes a substrate table constructed to hold a plurality of substrates at a plurality of exposable locations on the substrate table, respectively, and a projection system configured to project a patterned radiation beam onto a target portion of the plurality of substrates at the exposable locations. The substrate handler includes an unloader for unloading a plurality of substrates simultaneously from a plurality of respective exposure locations on a substrate table, and a carrier for receiving the plurality of substrates.

According to an embodiment of the present invention, there is provided a substrate handling apparatus for processing a plurality of substrates for use in a lithographic apparatus. The lithographic apparatus includes a substrate table constructed to hold a plurality of substrates at a plurality of exposable locations on the substrate table, respectively, and a projection system configured to project a patterned radiation beam onto a target portion of the plurality of substrates at the exposable locations. The substrate handling apparatus includes a loader for loading the plurality of substrates into the lithography apparatus directly from a substrate carrier.

According to an embodiment of the present invention, there is provided a device manufacturing method that includes projecting a patterned beam of radiation onto a plurality of substrates held on a substrate table constructed to hold the plurality of substrates at a plurality of locations on the substrate table, respectively.

According to an embodiment of the present invention, there is provided a device manufacturing method that includes transferring a pattern from a patterning device onto a plurality of substrates held on a substrate table constructed to hold the plurality of substrates at a plurality of locations on the substrate table, respectively.

According to an embodiment of the present invention, there is provided a program storage device that is readable by a processing apparatus. The device embodies a program of instructions executable by the processor to perform a method for controlling a lithographic apparatus. The method includes creating data relating to a plurality of substrates held at a plurality of exposable locations on a substrate table, respectively, maintaining the data relating to the plurality of substrates held on the substrate table, measuring the height of the plurality of substrates held on the substrate table, storing at least one of alignment grids, exposure data, and identification data associated with each of the plurality of substrates held on the substrate table, and controlling the lithographic apparatus based on the stored data.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a substrate table according to an embodiment of the invention;

FIG. 3(a) depicts a plan view of a substrate table according to an embodiment of the invention and FIG. 3(b) depicts by way of comparison a plan view of a conventional substrate table;

FIG. 4 depicts a substrate handler and a cross section of the substrate table along the line IV-IV in FIG. 2, according to an embodiment of the invention;

FIG. 5 depicts details of a substrate processing apparatus in operable association with details of a lithographic apparatus according to an embodiment of the invention;

FIG. 6 depicts a lithographic apparatus in operable association with a first and a second processing track and a control system for controlling at least one of the lithographic apparatus and the first and second processing tracks according to an embodiment of the invention; and

FIG. 7 depicts details of a control system for controlling the lithographic apparatus according to an embodiment of the present invention.

### DETAILED DESCRIPTION

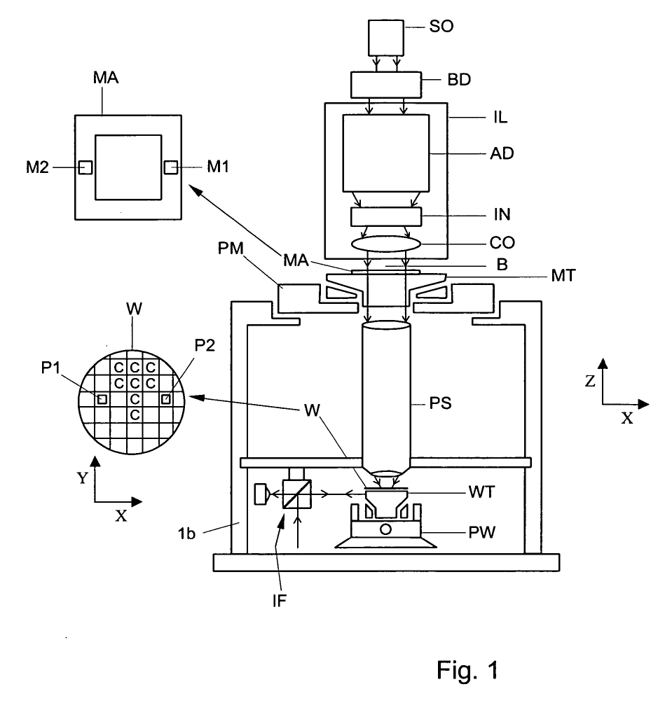

FIG. 1 schematically depicts a lithographic apparatus according to one embodiment of the invention. The apparatus includes: an illumination system (illuminator) IL configured to condition a radiation beam B (e.g. UV radiation, DUV, EUV or x ray radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. including one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT supports, i.e. bears the weight of, the patterning device MA. It holds the patterning device MA in a manner that depends on the orientation of the patterning device MA, the design of the lithographic apparatus, and other conditions, such as whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example, with respect to the projection system PS. Any use of the terms “reticle” or “mask” herein may be considered synonymous with the more general term “patterning device.”

The term “patterning device” as used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” as used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type in which at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example, when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases, the source may be an integral part of the lithographic apparatus, for example, when the source is a mercury lamp. The source SO and the illuminator IL, together with the beam delivery system BD if needed, may be referred to as a radiation system.

The illuminator IL may include an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT may be moved accurately, e.g. so as to position different target portions C in the path of the radiation beam B. Similarly, the first positioner PM and another position sensor (which is not explicitly depicted in FIG. 1) may be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner), the mask table MT may be connected to a short-stroke actuator only, or may be fixed. The mask MA and the substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus may be used in at least one of the following example modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

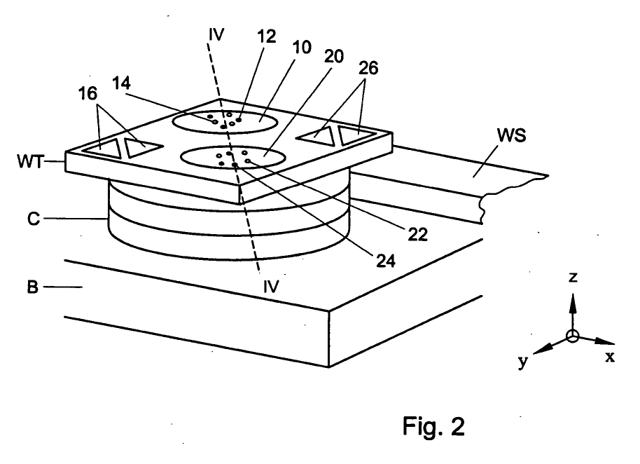

FIG. 2 depicts a substrate table WT according to an embodiment of the invention. The substrate table WT forms part of the substrate (or wafer) stage WS. The wafer stage WS includes a block, for example, a granite block B. The block B supports a chuck C, which in turn supports the substrate table WT. According to an embodiment of the present invention, the substrate table WT is constructed to hold a plurality of substrates at a plurality of respective locations 10, 20 on the substrate table WT. The plurality of locations are each exposable by the projection system PS. An exposable location is one onto which the projection system PS is able to project the patterned radiation beam. Typically, the plurality of locations are different from one another. Further, the projection system PS is configured to project the patterned radiation beam onto a target portion of the plurality of substrates that coincide with the locations 10, 20 on the substrate table WT. In this way, for example, two 200 mm substrates may be disposed for exposure on the substrate table WT constructed for use in a 300 mm lithographic apparatus. An advantage of disposing a plurality of substrates at respective locations 10, 20 on the substrate table WT is that the throughput of 200 mm substrates approaches two times that of a conventional 300 mm substrates in a lithography apparatus constructed to process 300 mm substrates. The throughput of a scanner in for example, a lithographic apparatus, is dependent upon various components. Of these, alignment and exposure time may be dependent upon the task the scanner is performing for the customer, as well as the machine engineering design. Other components may be dependent upon the machine design, such as wafer swap, moving from swap position to the exposure position and, in a dual stage apparatus, the chuck C swap between the exposure and measurement positions. With two 200 mm substrates, the area is approximately 89% of a single 300 mm substrate, so the exposure times of two 200 mm substrates is similar to that for one 300 mm substrate. The number of alignment marks on a 200 mm substrate is approximately half that for a 300 mm substrate so the align time of two 200 mm substrates is similar to that for one 300 mm substrate. With the ability to load and unload two wafers together, the total processing time for the two 200 mm substrates may be similar to that for one 300 mm substrate. Consequently, the 200 mm wafer throughput may approach double that of the 300 mm substrate throughput. In comparison for a single 200 mm substrate on the substrate table WT, the overhead times may be all the same as the overhead times for a 300 mm wafer, but the variable times, such as the alignment and exposure times, may be reduced. Consequently, the processing time for single 200 mm wafers on the substrate table may be more than half the processing time for a 300 mm wafer.

It has been found that throughput, and therefore customer value of a scanner designed primarily for 300 mm substrates, may be significantly improved when used with 200 mm substrates, without requiring major changes to the system design and keeping the possibility open to modify the tool back to 300 mm use later. Thus, the present invention may provide an efficient and versatile solution to the problem of increasing throughput. While the embodiment above is described with respect to 200 and 300 mm substrates, the invention is not limited in this respect, and may have application to any plurality of substrates disposed at any respective plurality of exposable locations on the substrate table WT. For example, four 3 inch substrates may be disposed on a 8 inch substrate table, four 6 inch wafers may be disposed on a 12 inch substrate table WT, or indeed, any number of substrates may be disposed on a substrate table WT that is specifically designed for multi-substrate processing. In one embodiment, the projection system PS is arranged to project a patterned radiation beam onto a target portion of the plurality of substrates in a single exposure.

A set of lifting pins 12, 22 is provided for each substrate W and a set of clamps 14, 24 is provided for each substrate W. In particular, the substrate table WT may be provided with at least one image sensor 16, 26 for sensing the image projected by the projection system PS on to each substrate W, respectively. Further, the substrate table WT may be provided with at least one alignment sensor 16, 26 for sensing the alignment of each substrate, respectively. Further, the substrate table WT may be provided with at least one intensity measuring element 16, 26 for measuring the intensity of the patterned radiation beam projected on to each substrate W, respectively. Yet further, each location 10, 20 arranged to receive a substrate W may be provided with a plurality of sets of substrate lifting pins 12, 22 arranged to lift each substrate, respectively. Further, each location 10, 20 arranged to receive a substrate W may be provided with a plurality of sets of clamps 14, 24 arranged to be able to clamp each substrate, respectively. In particular, the plurality of sets of at least one of substrate lifting pins and clamps are arranged to lift or clamp, respectively, each substrate independently of the other(s).

While conventional lifting pins and clamps may be used, their arrangement and operation according to embodiments of the present invention is not conventional. In particular, the operation of the lifting pins and clamps is not conventional, since in a conventional apparatus, the lifting pins and clamps in a substrate table WT are arranged and controlled to receive a single substrate.

In one embodiment of the invention, a lithographic projection apparatus is arranged to project a pattern from a patterning device onto a plurality of substrates, in which the plurality of substrates are mounted on a single substrate table constructed to hold the plurality of substrates. Thus, the present invention is applicable to optical lithography. The invention is not however, limited in this respect. In a further embodiment, there is provided a lithographic apparatus arranged to transfer a pattern from a patterning device onto a plurality of substrates, in which the plurality of substrates are disposed on a substrate table constructed to hold the plurality of substrates. Thus, the present invention has application to an imprint lithography apparatus.

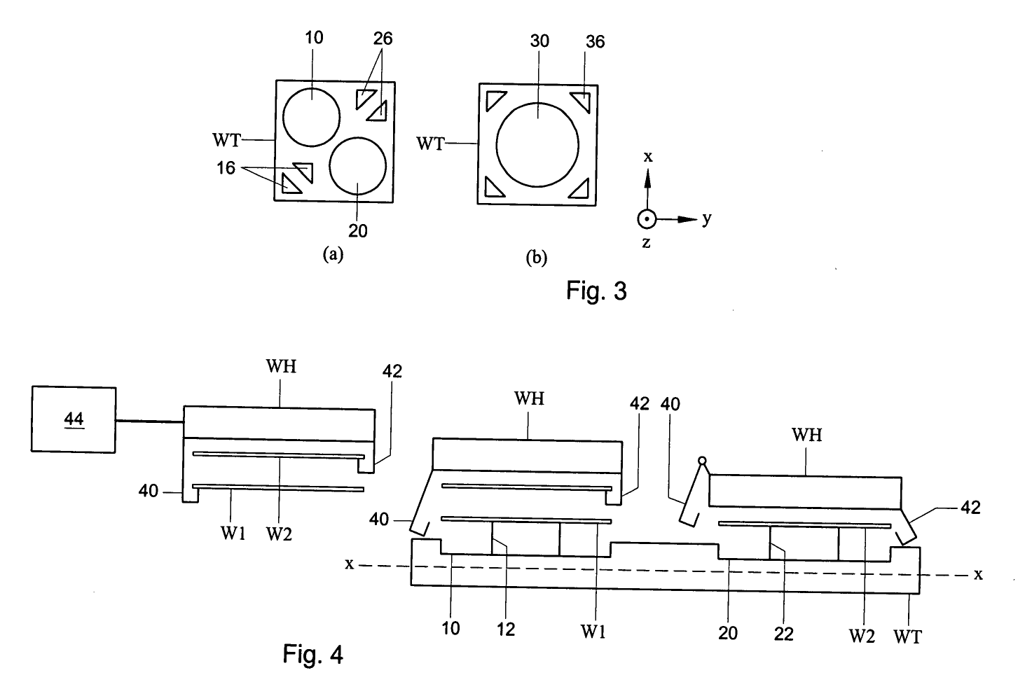

FIG. 3(a) depicts a plan view of a substrate table WT according to an embodiment of the invention, and FIG. 3(b) depicts by way of comparison a plan view of a conventional substrate table WT′. In particular, FIG. 3a shows, for example, two 8 inch substrates disposed at respective locations 10, 20 on a substrate table WT compared, in FIG. 3b to a single 12 inch substrate disposed at a single location 30 on the substrate table WT′. It is seen that the various image, sensors, alignment sensors, and intensity measuring devices 16, 26 shown in FIG. 3a for the substrate table WT, arranged to receive a plurality of substrates, are repositioned with respect to the sensors 36 shown in FIG. 3b for the substrate table WT′ that is arranged to receive only a single substrate. It has been found that by arranging the sensors 16, 26, for example, in opposite corners of the substrate table WT, the relevant quantities in the relevant directions may be effectively sensed. Further, as discussed above, for each location 10, 20, sets of lifting pins, also referred to in the art as E-pins, and sets of clamps may be provided. The clamps may include vacuum or other elements, for example, electrostatic elements.

FIG. 4 depicts a substrate handler WH and a cross section of the substrate table WT along the line IV-IV in FIG. 2, according to an embodiment of the invention. According to an embodiment of the invention, there is provided a substrate handler WH for handling a plurality of substrates W in a lithographic apparatus. The substrate handler WH includes a first gripper 40 for gripping a first substrate W1, a second gripper 42 for gripping a second substrate W2, and a control unit 44 for controlling the first and second grippers 40, 42, so that the first substrate W1 is disposed at a first location 10 on a substrate table WT and the second substrate W2 is disposed at a second location 20 on the substrate table WT. In this way, a similar substrate swap time of the two substrates W1 and W2 may be achieved with respect to a single substrate holding substrate table WT, as shown, for example, in FIG. 3b. In particular, FIG. 4 shows a substrate loading sequence according to an embodiment of the invention. The substrate handler WH includes a first and second gripper 40, 42. The first gripper 40 grips a first substrate W1. The second gripper 42 grips a second substrate 42. The first and second substrates are destined for first and second locations 10, 20, respectively. During the loading sequence, the control unit 44 controls the substrate handler WH so that it is disposed adjacent the first location 10. The control unit 44 then controls the first gripper 40 to release the first substrate W1 at the first location 10. Once in place, the first substrate W1 is supported at the first location 10 on lifting pins 12. Subsequently, the control unit 44 controls the substrate handler WH so that it is disposed adjacent the second location 20. The control unit 44 then controls the second gripper 42 to release the second substrate W2 at the second location 20. Once in place, the second substrate W2 is supported at the second location 20 on lifting pins 22. In this way, the substrates W1, W2 may be efficiently loaded without increasing the load time significantly with respect to a conventional substrate handler that loads only one substrate. In particular, the substrates W1, W2 may be lifted on two separate grippers fitted to the same robot, and the control unit 44 may control the robot. In FIG. 4, in the center image, the wafer handler WH has long grippers 40, 42 arranged to carry one substrate below the other. In the right hand image, the long grippers 40 are arranged to fold up in order to get out of the way to allow the second wafer to be deposited. In an embodiment, a plurality, preferably three, grippers may be provided for each substrate. When viewed from above, that is along the Z-axis in a plan view, the three grippers are seen to be arranged at 120° to each other.

In a further embodiment, there is provided a method of handling a plurality of substrates W in a lithographic apparatus. The method includes providing a substrate handler WH1 that has a first and a second gripper 40, 42, gripping a first substrate W1 with the first gripper 40, gripping a second substrate W2 with the second gripper 42, and controlling the substrate handler WH1 so that the first substrate W1 is released at a first location 10 on a substrate table WT, and the second substrate W2 is released at a second location 20 on the substrate table WT.

It will be understood that FIG. 4 shows just one embodiment of the substrate handling arrangement according to an aspect of the present invention. In FIG. 4, it is seen that two substrates may be carried one above the other, and loaded (or unloaded) sequentially on to the substrate table. In an alternative embodiment, a handler is provided that carries two substrates side-by-side and is arranged to load, or unload, both substrates simultaneously from the substrate table.

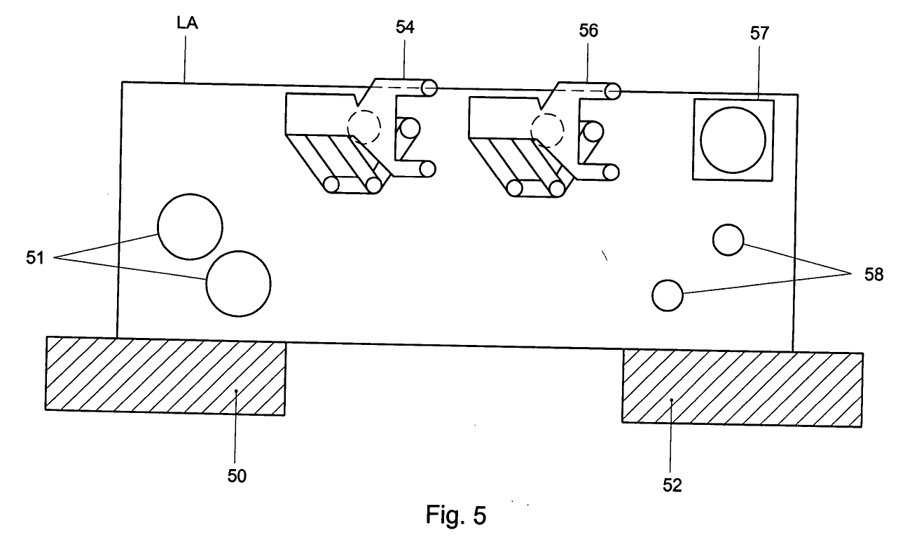

FIG. 5 depicts details of a substrate handling apparatus in operable association with a lithographic apparatus LA according to an embodiment of the invention. In one embodiment of the invention, there is provided a substrate handling apparatus for processing a plurality of substrates W for use in a lithographic apparatus. The apparatus includes a first processing track 50 for coating the plurality of substrates W to be supplied to the lithographic apparatus, and a second different processing track 52 for developing the plurality of substrates W once they exit the lithographic apparatus. The first and second processing tracks 50, 52 are arranged to be operationally associated with the lithographic apparatus LA. In a particular embodiment, the first processing track 50 is an input track arranged to input the plurality of substrates into the lithographic apparatus LA. In a further embodiment, the second processing track 52 is an output track arranged to output the plurality of substrates W from the lithographic apparatus LA. In FIG. 5, the first and second processing tracks 50, 52 are operationally associated with a lithographic apparatus LA. In particular, FIG. 5 shows details of the substrate loading and unloading apparatus of the lithographic apparatus LA. The loading and unloading sequence to load and unload the substrates may typically be as follows: the output robot (not shown) of track 50 deposits two substrates on the pre-aligners 51. The pre-aligners 51 provide the pre-alignment function. The output robot 56, which may be embodied by the wafer handler WH described hereinabove, is arranged to take the substrates from the substrate table (not shown) and deposits them on the output pedestals 58. Further, the input robot 54 removes the substrates from the pre-aligners and transfers the substrates to the substrate table (not shown). Further, the track 52 input robot removes the wafers from the output pedestals 58 for development.

In contrast to conventional substrate loading and unloading systems, it has been found that the provision of two pre-aligners 51, rather than the conventional one pre-aligner, may further increase the throughput of the lithographic apparatus. It has been found that the pre-align time is typically greater than half the substrate processing time. Also shown in FIG. 5 is a carrier handler 57 that is arranged to provide an alternative input or output route for substrates. This may enable substrates to be input to or output from the lithography scanner, without the need to be processed by the tracks. For example, such substrates may be used for tests or reject substrates that are collected.

It will be understood that FIG. 5 shows just one embodiment of the system. In an alternative embodiment, robots 54 and 56 may be replaced by a single robot. Further, the plurality of substrates may be loaded from or output to a series of carrier handlers. Further, the output pedestals may be located in the output track. In one embodiment, there is provided a substrate handling apparatus for processing a first substrate and a second substrate for use in a lithographic apparatus. The handling apparatus includes a first processing track 50 and a second processing track 52. The first processing track 50 may be arranged to coat the first substrate to be supplied to the lithographic apparatus, and to develop the first substrate once it exits the lithographic apparatus, and the second processing track 52 may be arranged to coat the second substrate to be supplied to the lithographic apparatus, and to develop the second substrate once it exits the lithographic apparatus. The first and second processing tracks 50, 52 may be arranged to be operationally compatible with the lithographic apparatus. In this way, the rate at which substrates are provided to the lithographic apparatus may be increased. In an alternative embodiment, there is provided a substrate handling apparatus for processing a first plurality of substrates and a second plurality of substrates for use in a lithographic apparatus. The handling apparatus includes a first processing track 50 and a second processing track 52. The first processing track 50 may be arranged to coat the first plurality of substrates to be supplied to the lithographic apparatus, and to develop the first plurality of substrates once they exit the lithographic apparatus, and the second processing track 52 may be arranged to coat the second plurality of substrates to be supplied to the lithographic apparatus, and to develop the second plurality of substrates once they exit the lithographic apparatus. The first and second processing tracks 50, 52 may be arranged to be operationally compatible with the lithographic apparatus. The substrate handling apparatus further includes a buffer 61 for buffering the first and second plurality of substrates at an interface between the first and second processing tracks and the lithographic apparatus, so that the first and second plurality of substrates may be processable in a predetermined order in the lithographic apparatus, and returnable to the first and second processing tracks 50, 52, respectively. The predetermined order may, for example, be that substrates are loaded in to the lithographic apparatus alternatively from the first and second processing tracks 50, 52. The provision of a buffer 61 at the interface between the first and second tracks 50, 52 and the lithographic apparatus improves the flexibility with which the substrates may be provided to the lithographic apparatus.

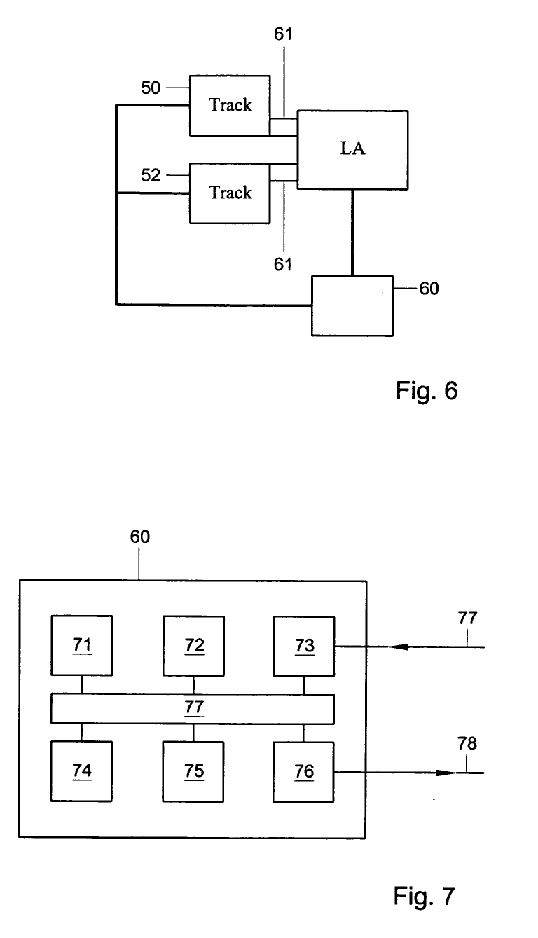

FIG. 6 depicts a lithographic apparatus LA in operable association with a first and a second processing track 50, 52, and a control system 60 for controlling at least one of the lithographic apparatus LA, and the first and second processing tracks 50, 52, according to an embodiment of the invention. Conventional track designs include a robot surrounded by both coating and developing stations. With such conventional arrangements, tracks are capable of a throughput of up to around 150 substrates per hour, that is the coating station coats 150 substrates per hour, the developing stations develop 150 substrates per hour. Thus, in one hour, 300 substrates flow through the track. According to an embodiment of the invention, as described above, two tracks 50, 52 are provided. The first track 50 may be set up with only coating stations, and the second track 52 may be set up with only developing stations. In this way, a yet further increased throughput may be achieved. Taking the example discussed above, a throughput of 300 substrates per hour may be achieved. The control system 60 may be arranged to control at least one of the first and second tracks 50, 52 and the lithographic apparatus LA, which, as shown in FIG. 6 may be a multi-stage apparatus, described above. In an alternative embodiment, a first processing track that includes a coating and a developing station may be provided, and a second processing track may be provided that includes a coating and a developing station. In this particular embodiment, the first processing track may be arranged to process the first of a plurality of substrates, and the second processing track may be arranged to process the second of the plurality of substrates.

FIG. 7 depicts details of a control system 60 for controlling the lithographic apparatus according to an embodiment of the present invention. The control system 60 according to an embodiment of the present invention may differ from the control system of a conventional apparatus in several ways. Since, according to an embodiment of the invention, the substrate table WT may be arranged to support a plurality of substrates W located at a plurality of respective locations, it has been found that, depending on the number of the plurality of substrates, a plurality of sets of substrate data may be created and maintained, a plurality of substrates may be measured to determine the height at various locations on each substrate, as well as a plurality of substrate alignment grids and exposure data and substrate identification numbers may be monitored. Further, the apparatus set-up sequence and adjustment tests may be adapted to be able to cope with a plurality of substrates per substrate table WT. The substrate height measuring unit 73 may be arranged to measure the height of the plurality of substrate held on the substrate table. In one embodiment, the substrate height measuring unit 73 may be arranged to make measurements of the wafer and construct a contour map of the surface in one area of the apparatus. Subsequently, the map may be followed at exposure. In an alternative embodiment, the substrate height measuring unit 73 may be arranged to measure the wafer and follow the wafer shape during exposure. Thus, it will be understood that the control system 60 may be arranged to measure and follow synchronously or, alternatively, the control system may measure and follow later.

According to an embodiment of the invention, there is provided a control system 60 for controlling a lithographic apparatus. The control system 60 may include a data creation unit 71 for creating data relating to a plurality of substrates W held on a substrate table WT, a data maintaining unit 72 for maintaining the data relating to the plurality of substrates W held on the substrate table WT, a substrate height measuring unit 73 for measuring the height of the plurality of substrates W held on the substrate table WT, a data storage unit 74 for storing at least one of alignment grids, exposure data, and identification data associated with each of the plurality of substrates W held on the substrate table WT. In a further embodiment, the control system 60 may include a set-up unit 75 arranged to perform a set up sequence adapted to accommodate the plurality of substrates W held on the substrate table WT. In yet a further embodiment, there is provided an adjustment test unit 76 for performing adjustment tests on the plurality of substrates W held on the substrate table WT. Each unit may include a processing unit and a data storage unit. Alternatively, a local or remote processing unit and/or data storage unit may be provided. Input data 77 corresponding, for example, to the data sensed by sensors 16, 26, 36 is input to the control unit 60 via an input line. A control signal 78 is provided by the control system 60 in response to the input data 77. The control signal 78 is provided to at least one of the first, second track 50, 52 and lithographic apparatus LA. In a further embodiment, there is provided a method of controlling a lithographic apparatus. The method includes creating data relating to a plurality of substrates held on a substrate table, maintaining the data relating to the plurality of substrates held on the substrate table, measuring the height of the plurality of substrates held on the substrate table, and storing at least one of alignment grids, exposure data, and identification data associated with each of the plurality of substrates held on the substrate table.

In a further embodiment, there is provided a program storage device readable by a processing apparatus. The device embodies a program of instructions executable by the processor to perform the control method described above.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in, for example, a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example, in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example, imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” as used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus comprising:
a substrate table constructed and arranged to hold a plurality of substrates at a plurality of respective exposable locations on the substrate table; and
a projection system constructed and arranged to project a patterned radiation beam onto respective target portions of the plurality of substrates at the exposable locations.

2. A lithographic apparatus according to claim 1, wherein the plurality of locations are different.

3. A lithographic apparatus according to claim 1, wherein the substrate table is provided with at least one image sensor for sensing the image projected by the projection system onto each substrate, respectively.

4. A lithographic apparatus according to claim 1, wherein the substrate table is provided with at least one alignment sensor for sensing the alignment of each substrate, respectively.

5. A lithographic apparatus according to claim 1, wherein the substrate table is provided with at least one intensity measuring element for measuring the intensity of the patterned radiation beam projected on to each substrate, respectively.

6. A lithographic apparatus according to claim 1, wherein the substrate table is provided with a plurality of sets of substrate lifting pins arranged to lift each substrate, respectively.

7. A lithographic apparatus according to claim 6, wherein the plurality of sets of substrate lifting pins are arranged to lift each substrate independently of the other(s).

8. A lithographic apparatus according to claim 1, wherein the substrate table is provided with a plurality of sets of clamps arranged to be able to clamp each substrate, respectively.

9. A lithographic apparatus according to claim 8, wherein the plurality of sets of clamps are arranged to clamp each substrate independently of the other(s).

10. A lithographic projection apparatus arranged to project a pattern from a patterning device onto a plurality of substrates, wherein the plurality of substrates are mounted on a single substrate table constructed to hold the plurality of substrates at a plurality of exposable locations, respectively.

11. A lithographic apparatus arranged to transfer a pattern from a patterning device onto a plurality of substrates, wherein the plurality of substrates are disposed on a substrate table constructed to hold the plurality of substrates at a plurality of exposable locations, respectively.

12. A control system for controlling a lithographic apparatus, the control system comprising:
a data creation unit for creating data relating to a plurality of substrates held at a plurality of exposable locations on a substrate table, respectively;
a data maintaining unit for maintaining the data relating to the plurality of substrates held on the substrate table;
a substrate height measuring unit for measuring the height of the plurality of substrates held on the substrate table; and
a data storage unit for storing alignment grids, or exposure data, or identification data, or any combination thereof, associated with each of the plurality of substrates held on the substrate table.

13. A control system according to claim 12, further comprising a set-up unit arranged to perform a set up sequence adapted to accommodate the plurality of substrates held on the substrate table.

14. A control system according to claim 12, further comprising an adjustment test unit for performing adjustment tests on the plurality of substrates held on the substrate table.

15. A method of controlling a lithographic apparatus, the method comprising:
creating data relating to a plurality of substrates held at a plurality of exposable locations on a substrate table, respectively;
maintaining the data relating to the plurality of substrates held on the substrate table;
measuring the height of the plurality of substrates held on the substrate table;
storing alignment grids, or exposure data, or identification data, or any combination thereof, associated with each of the plurality of substrates held on the substrate table; and
controlling the lithographic apparatus based on the stored data.

16. A substrate handler for handling a plurality of substrates in a lithographic apparatus, the substrate handler comprising:
a first gripper for gripping a first substrate;
a second gripper for gripping a second substrate; and
a control unit for controlling the first and second grippers so that the first substrate is disposed at a first location on a substrate table and the second substrate is disposed at a second location on the substrate table, wherein the first and second substrates are exposable at the first and second locations on the substrate table, respectively.

17. A method of handling a plurality of substrates in a lithographic apparatus, the method comprising:
gripping a first substrate with a first gripper of a substrate holder;
gripping a second substrate with a second gripper of the substrate holder; and
controlling the first and second grippers so that the first substrate is released at a first exposable location on a substrate table, and the second substrate is released at a second exposable location on the substrate table.

18. A substrate handling apparatus for processing a plurality of substrates for use in a lithographic apparatus, the handling apparatus comprising:
a first processing track for coating the plurality of substrates to be supplied to the lithographic apparatus; and
a second different processing track for developing the plurality of substrates once they exit the lithographic apparatus,
wherein the first and second processing tracks are arranged to be operationally compatible with the lithographic apparatus.

19. A substrate handling apparatus according to claim 18, wherein the first processing track is an input track arranged to input the plurality of substrates to the lithographic apparatus.

20. A substrate handling apparatus according to claim 18, wherein the second processing track is an output track arranged to output the plurality of substrates from the lithographic apparatus.

21. A lithographic apparatus for use with substrate handling apparatus according to claim 18, wherein the lithographic apparatus comprises an input robot associated with the first processing track, and an output robot associated with the output track, wherein the input robot receives the plurality of substrates from the first processing track and disposes the plurality of substrates on a substrate table and the output robot supplies the plurality of substrates from the substrate table to the second processing track.

22. A lithographic apparatus according to claim 21, wherein the input robot comprises a substrate handler comprising a first gripper for gripping a first substrate, a second gripper for gripping a second substrate, and a control unit for controlling the first and second grippers so that the first substrate is disposed at a first location on a substrate table and the second substrate is disposed at a second location on the substrate table, wherein the first and second substrates are exposable at the first and second locations, respectively.

23. A substrate handling apparatus for processing a first substrate and a second substrate for use in a lithographic apparatus according to claim 1, the handling apparatus comprising a first processing track and a second processing track, wherein the first processing track is arranged to coat the first substrate, to be supplied to the lithographic apparatus and to develop the first substrate once it exits the lithographic apparatus and the second processing track is arranged to coat the second substrate, to be supplied to the lithographic apparatus and to develop the second substrate once it exits the lithographic apparatus, wherein the first and second processing tracks are arranged to be operationally compatible with the lithographic apparatus.

24. A substrate handling apparatus for processing a first plurality of substrates and a second plurality of substrates for use in a lithographic apparatus according to claim 1, the handling apparatus comprising:
a first processing track, the first processing track being arranged to coat the first plurality of substrates to be supplied to the lithographic apparatus and to develop the first plurality of substrates once they exit the lithographic apparatus;
a second processing track, the second processing track being arranged to coat the second plurality of substrates to be supplied to the lithographic apparatus and to develop the second plurality of substrates once they exit the lithographic apparatus, the first and second processing tracks being arranged to be operationally compatible with the lithographic apparatus; and
a buffer for buffering the first and second plurality of substrates at an interface between the first and second processing tracks and the lithographic apparatus so that the first and second plurality of substrates are processable in a predetermined order in the lithographic apparatus and returnable to the first and second processing tracks, respectively.

25. A substrate handler for use in a lithographic apparatus according to claim 1, the substrate handler comprising a carrier for carrying a plurality of substrates and a loader for loading the plurality of substrates simultaneously to a plurality of respective exposure locations on the substrate table.

26. A substrate handler for use in a lithographic apparatus according to claim 1, the substrate handler comprising an unloader for unloading a plurality of substrates simultaneously from a plurality of respective exposure locations on a substrate table and a carrier for receiving the plurality of substrates.

27. A substrate handling apparatus for processing a plurality of substrates for use in a lithographic apparatus according to claim 1, the substrate handling apparatus comprising a loader for loading the plurality of substrates into the lithography apparatus directly from a substrate carrier.

28. A device manufacturing method comprising projecting a patterned beam of radiation onto a plurality of substrates held on a substrate table constructed to hold the plurality of substrates at a plurality of locations on the substrate table, respectively.

29. A device manufacturing method comprising transferring a pattern from a patterning device onto a plurality of substrates held on a substrate table constructed to hold the plurality of substrates at a plurality of locations on the substrate table, respectively.

30. A program storage device readable by a processing apparatus, the device embodying a program of instructions executable by the processor to perform a method of controlling a lithographic apparatus, the method comprising:
creating data relating to a plurality of substrates held at a plurality of exposable locations on a substrate table, respectively;
maintaining the data relating to the plurality of substrates held on the substrate table;
measuring the height of the plurality of substrates held on the substrate table;
storing alignment grids, or exposure data, or identification data, or any combination thereof, associated with each of the plurality of substrates held on the substrate table; and
controlling the lithographic apparatus based on the stored data.
